(19) United States
(12) Patent Application Publication
(10) Pub. No.: US 2016/0103930 A1
(43) Pub. Date: Apr. 14, 2016

(54) SYSTEM AND METHOD FOR PROVIDING ANALYTICS RESPECTIVE OF CONTEXTUAL DATA

(71) Applicant: Harmon.ie R&D Ltd., Lod (IL)

(72) Inventor: Roy Sheinfeld, Tel Aviv (IL)

(73) Assignee: HARMON.IE R&D LTD., Lod (IL)

(21) Appl. No.: 14/872,632

(22) Filed: Oct. 1, 2015

Related U.S. Application Data
(60) Provisional application No. 62/062,905, filed on Oct. 12, 2014.

(51) Int. Cl. G06F 17/30

(52) U.S. Cl. CPC G06F 17/30946; G06F 17/30864

(57) ABSTRACT

A system and method for generating analytics based on contextual data are presented. The method includes identifying at least one tag for a portion of data; determining at least one topic based on the identified at least one tag, wherein each topic is a descriptive contextual term; continuously monitoring data from a plurality of data sources respective of each topic; and generating, for each topic, an analytic based on the monitored data.

### CROSS-REFERENCE TO RELATED APPLICATIONS

This application claims the benefit of U.S. Provisional Application No. 62/062,905 filed on Oct. 12, 2014, the contents of which are hereby incorporated by reference.

### TECHNICAL FIELD

The present disclosure relates generally to analyzing contextual data, and more particularly to providing analytics respective of contextual data.

### BACKGROUND

A significant problem faced by enterprises' workers is processing the sheer volume of information being delivered on a regular basis. The adoption of multiple cloud servers by many organizations has further exacerbated the problem, thereby leading to information that is not only abundant, but also disconnected. Consequently, workers feel information overload and stress.

The most effective way to reduce information overload and increase productivity is to filter out irrelevant and unimportant information such that workers are only presented with information that is necessary for daily tasks. However, filtering data coming from multiple sources can be difficult, particularly when unstructured data is involved. Further, the information may not be easily associated among different sources and, as a result, correlating such information becomes more challenging.

Additionally, some portions of data may be more relevant depending on the time of year, recent events, and/or trends related to the enterprise. For example, when the holiday shopping season approaches, information related to alternative toy vendors may be more relevant to a toy company because the company may need to utilize alternative vendors to fill orders as the number of orders increases. As another example, information related to particular stocks may become more relevant to members of a stock brokerage firm when the value of the stock begins to rise or fall rapidly. As yet another example, information related to a particular celebrity may become more relevant to a consumer of celebrity gossip when the celebrity is involved in a scandal.

The field of analytics seeks to analyze data to yield meaningful patterns that can then be used to draw conclusions about the data. With the increasing focus on Internet-based activities, far greater numbers of business have become interested in pursuing analytics to learn more about their performance with respect to their customers, employees, competitors, products, and so on. The process of analyzing such data can require extensive computation, thereby leading to the challenge of devoting sufficient resources for generating analytics.

The challenges of analytics increase significantly when the data is derived from a wide variety of sources. These challenges are further compounded by increased usage of cloud computing applications and a corresponding increased need to analyze different types of data, including both structured (i.e., limited to a particular field) and unstructured (i.e., unsorted) data. Whereas such challenges were previously faced exclusively by the scientific community, shifts in intelligence-gathering operations toward increasingly Internet-based systems have led to a much greater need to process large volumes of both structured and unstructured data. However, existing solutions for performing analytics are limited in that such solutions face challenges in processing unstructured data and in processing data across cloud sources.

It would therefore be advantageous to provide a solution that would overcome the deficiencies of the prior art by providing analytics respective of data and, in particular, cross-cloud data.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain exemplary embodiments disclosed herein include a method for generating analytics based on contextual data are presented. The method comprises identifying at least one tag for a portion of data; determining at least one topic based on the identified at least one tag, wherein each topic is a descriptive contextual term; continuously monitoring data from a plurality of data sources respective of each topic; and generating, for each topic, an analytic based on the monitored data.

Certain exemplary embodiments disclosed herein also include a system for generating analytics based on contextual data. The system comprises a processing unit; and a memory, the memory containing instructions that, when executed by the processing unit, configure the system to: identify at least one tag for a portion of data; determine at least one topic based on the identified at least one tag, wherein each topic is a descriptive contextual term; continuously monitor data from a plurality of data sources respective of each topic; and generate, for each topic, an analytic based on the monitored data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments;

FIG. 2 is a schematic diagram of an agent installed on a client node according to an embodiment;

FIG. 3 is a flowchart illustrating a method for analytics generation based on contextual data according to an embodiment; and

FIG. 4 is a flowchart illustrating a method for generating analytics based on topics according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating analytics. Tags are identified in portions of data. Based on the identified tags, a topic is determined for each portion of data. Data is monitored respective of each topic. Analytics are generated based on the monitored data. In an embodiment, generating the analytics may further include analyzing commonalities within the data to identify meaningful patterns.

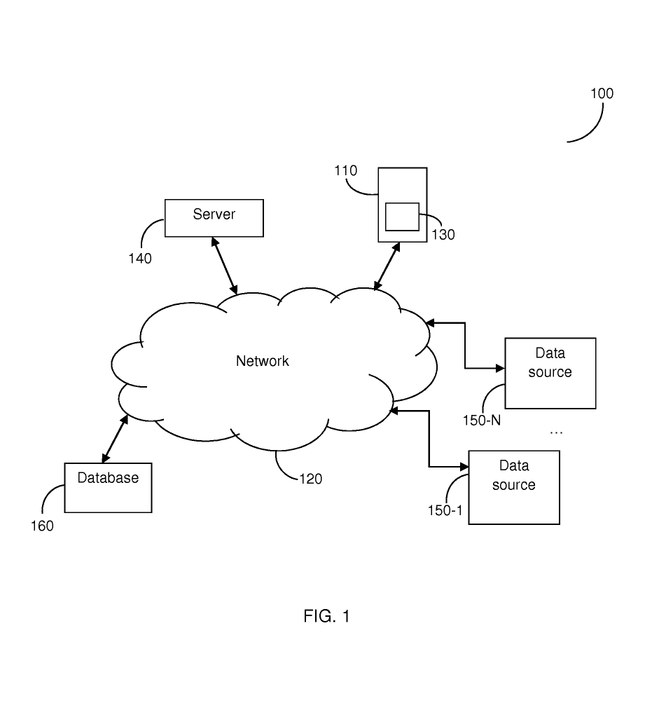

FIG. 1 shows an exemplary and non-limiting network diagram 100 utilized to describe the various disclosed embodiments. A client node 110 is communicatively connected to a network 120. The client node 110 may be, for example, a personal computer, a tablet computer, a laptop computer, a smart phone, a wearable computing device, and so on. The network 120 may be wireless, cellular or wired, a local area network (LAN), a wide area network (WAN), a metro area network (MAN), the Internet, the worldwide web (WWW), and any combination thereof.

The client node 110 includes an agent 130 installed therein. The agent 130 may be implemented as an application program configured based on instructions stored in a memory (not shown) of the client node 110. The agent 130 is further communicatively connected to a server 140 over the network 120. It should be noted that only one client node 110 including one agent 130 therein is described herein merely for simplicity purposes and without limitation on the disclosed embodiments. Multiple client nodes including multiple agents may be utilized without departing from the scope of the disclosed embodiments.

In an embodiment, the agent 130 monitors a plurality of data sources 150-1 through 150-N (hereinafter referred to individually as a data source 150 and collectively as data sources 150, merely for simplicity purposes) and collects data therefrom. Each data source 150 may be a cloud-based data source. The data sources 150 may include, but are not limited to, databases, social networks, enterprise networks, chat applications, and so on. Each data source 150 is communicatively connected to the network 120. The agent 130 sends collected data to the server 140 over the network 120.

The collected data may include structured data, unstructured data, and a combination thereof. Structured data is data stored in a fixed field which may be, e.g., data stored with respect to one or more web-based applications such as social media networks, management applications, collaborative applications, and so on. The structured data may include, but is not limited to, managed data in SharePoint®, Yammer® topics, Chatter® hashtags, and so on. The unstructured data is not stored in a fixed field and may include, but is not limited to, a document, a message (e.g., an email message), a chat correspondence, a short message service (SMS) message, images, video clips, calendar event descriptions, and combinations thereof.

The collected data is analyzed by the server 140 to identify at least one tag for each portion of the data. A tag is a predetermined index assigned to a textual term. It should be noted that one or more tags can be assigned to the same term. As a non-limiting example, the tags “computer” and “portable device” may be assigned to the textual term “smartphone.” Based on the identified tags, the server 140 is configured to generate at least one topic for each portion of the collected data. Each topic is a descriptive contextual term that indicates the context of a certain portion of data. As a non-limiting example, tags related to a “contract” and to a “shipment of goods,” respectively, may be utilized to generate a topic “contract for the sale of goods.”

The topics are monitored by the server 140. In an embodiment, the topic monitoring may include crawling through the data sources 150 to gather data related to the topic. Data may be related to a topic if, e.g., the data is associated with a tag of the topic, the data is associated with each tag of the topic, and so on. In an embodiment, the topics are monitored and/or data is gathered until a monitoring threshold is reached. The monitoring threshold ensures that sufficient data is monitored respective of the topics to identify meaningful patterns therein. The monitoring threshold may be, but is not limited to, a period of time, a total amount of data, and so on.

Respective of the monitoring, the server 140 generates analytics. The analytics may be related to, but not limited to: the topic, the client node 110, and/or the data sources 150. Analytics are illustrative sets of data utilized to demonstrate meaningful patterns in the monitored data. As a non-limiting example, an analytic based on the topic “contract for the sale of goods” may illustrate that documents associated with such contracts (e.g., the contracts themselves) are stored in large quantities on a regular basis (e.g., every month, every year, every five years, and so on). Further, such data may enable the server 140 to provide predictions related to certain customers, employees, cash-flow, and so on. As a non-limiting example, for an analytic demonstrating that large volumes of contracts for the sale of goods are made on a regular basis, the server 140 may be able to predict gains or losses in revenue based on frequency of contract formation, an average price of such contracts, and whether the entity is selling or buying the goods.

In a further embodiment, upon identification of an appearance of at least one topic above a trend threshold, a trend is determined by the server 140 and generated as an analytic. The trend thresholds may be predetermined either automatically by the server 140 or by a network administrator. The trend thresholds may be extracted from a database 160 communicatively connected to the server 140 over the network 120. Each trend threshold may be, but is not limited to, a number of appearances per time period (e.g., a week, a month, a year, etc.), a total number of appearances, and so on. As a non-limiting example, if the topic “request to install pool in backyard” appears more than 10 times in a given month, a trend for pool installation may be determined.

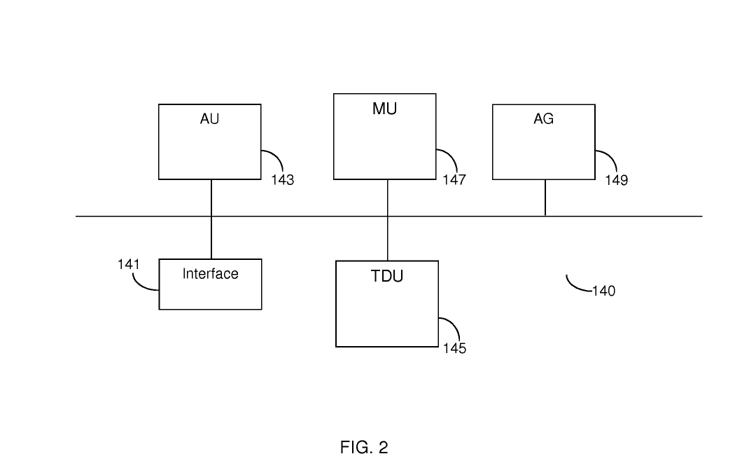

FIG. 2 depicts an exemplary and non-limiting schematic diagram of the server 140 according to an embodiment. The server 140 includes an interface 141 through which data is collected and sent over the network 120. The collected data is analyzed by an analyzing unit 143 to identify at least one tag for the data.

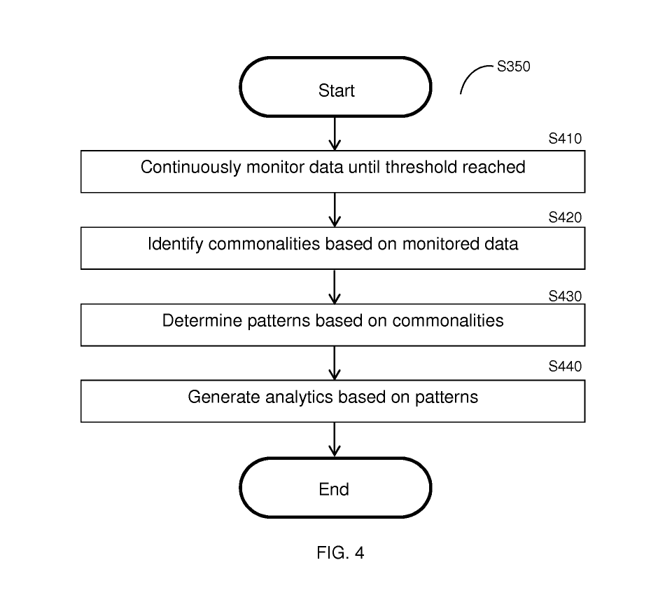

The server 140 further includes a topic determination unit (TDU) 145. The TDU 145 is configured to generate at least one topic respective of each portion of the data based on the at least one tag. The topics are monitored by the monitoring unit (MU) 147. The monitoring may include, but is not limited to, crawling through the data sources 150 and gathering data associated with the topic(s). Respective of the monitoring, an analytics generator (AU) 149 generates at least one analytic associated with at least one topic. Generation of analytics based on topics is described further herein below with respect to FIG. 4.

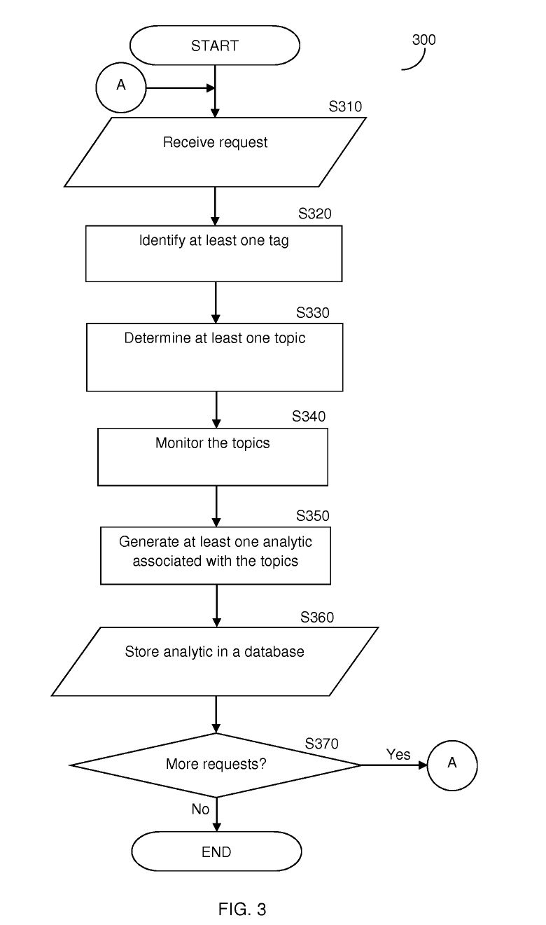

FIG. 3 is an exemplary and non-limiting flowchart 300 illustrating a method for analytics generation based on contextual data according to an embodiment. In S310, a request to generate analytics based on a portion of data is received. The request may include the portion of data.

In S320, at least one tag is identified for the data. Each tag is a predetermined index assigned to a textual term. It should be noted that multiple tags can be assigned to the same term. In an embodiment, the at least one tag may be identified by matching the textual term that the tag is assigned to with the portion of data. Upon identifying a match, the tag may be identified respective of the portion.

In S330, at least one topic is determined for the portion of the data based on the at least one tag. Each topic is a descriptive contextual term that indicates the context of a certain portion of the data. Each topic may be associated with one or more tags. In an embodiment, each topic may be identified by matching the identified at least one tag to the tags associated with the topic. If each tag associated with a particular topic matches one or more of the identified at least one tag, the topic may be determined.

In S340, the determined topics are continuously monitored. In an embodiment, the monitoring may further include gathering data related to the determined at least one topic. In an embodiment, the topics may be continuously monitored until a monitoring threshold is reached. The monitoring threshold ensures that sufficient data is monitored such that meaningful patterns can be determined within the data. The monitoring threshold may be predefined and may include, but is not limited to, a time period (e.g., a week, a month, a year, etc.), a total size of the gathered data (e.g., 6 megabytes, 1 gigabyte, etc.), a number of appearances of a topic in the gathered data (e.g., 5 times, 10 times, 100 times, etc.), and so on.

In S350, at least one analytic is generated respective of the monitoring topics. Analytics are illustrative sets of data used to demonstrate meaningful patterns in the monitored data. Each analytic may be related to, but not limited to, one of the topics, a user device (e.g., the client device 110), a data source (e.g., the data source 150), and so on. Such analytics may include, for example, data related to client nodes that edited content related to the topic, data indicating activity of a user of a client node, that searched for the topic, that searched for data related to documents associated with the topic and time pointers related to their addition, and so on. Such analytics may further be used for comparison to similar topics. Furthermore, such analytics may be used for predicting future behavior of similar topics. Generation of analytics respective of topics is described further herein below with respect to FIG. 4.

In S360, the analytic(s) are stored in the database 160 for further use. In S370, it is checked whether additional requests have been received and, if so, execution continues with S310; otherwise, execution terminates.

As a non-limiting example, unstructured data is collected from a plurality of data sources. The unstructured data is analyzed and two tags are identified based on the unstructured data. The two identified tags are “loan” and “Bank of America Merrill Lynch®”. Respective of the two tags, the topic “loan from Bank of America Merrill Lynch®” is generated. The topic is then monitored and analytics are generated respective thereof. In this example, it is determined that a pattern involving the topic “loan from Bank of America Merrill Lynch®” appears regularly once per year and that the appearances of this topic coincides with documents illustrating appearances of topics related to purchases of goods made by an entity. As a result, an analytic demonstrating that, annually, there will be an influx of cash followed by a withdrawal and receipt of goods is determined.

FIG. 4 is an exemplary and non-limiting flowchart S350 illustrating a method for generating analytics respective of topics according to an embodiment. In S410, data is continuously monitored respective of at least one topic. The data may be structured and/or unstructured. The monitoring involves gathering data related to the at least one topic. A portion of data may be related to the at least one topic when, e.g., the portion of data is associated with a tag of the at least one topic, the portion of data is associated with each tag of the at least one topic, and so on.

In an embodiment, the at least one topic is continuously monitored until a monitoring threshold is reached. The monitoring threshold is a threshold utilized to ensure that sufficient data is monitored to demonstrate a meaningful pattern related to the at least one topic. The monitoring threshold may be predefined and may include, but is not limited to, a time period (e.g., a week, a month, a year, etc.), a total size of the gathered data (e.g., 6 megabytes, 1 gigabyte, etc.), a number of appearances of a topic in the gathered data (e.g., 5 times, 10 times, 100 times, etc.), and so on. In a further embodiment, additional topics may be identified during monitoring, and the monitoring may also be performed respective of the newly identified topics.

In S420, portions of the monitored data are analyzed to identify at least one commonality among portions of the data. Commonalities are features of the analyzed data that are common among two or more portions of the analyzed data and are related to the appearance of topic. Commonalities may include, but are not limited to, a source of the data (e.g., a client node, a username, a geographic location, etc.), a context of a use of the data (e.g., the data being edited, the data being entered into a search engine, the data appearing in a document, the data appearing in another source, etc.), a time of use of the data (e.g., a particular minute, hour, day, week, month, year, etc.), and so on.

In S430, the at least one commonality is analyzed to determine at least one pattern. A pattern is a grouping of data based on commonalities. In an embodiment, a pattern is determined when the amount of data (e.g., a total amount of data, a number of portions of data, a percentage of the total monitored data, etc.) related by a commonality is above a commonality threshold. The commonality threshold may be utilized to ensure that any identified patterns are meaningful rather than coincidental. As a non-limiting example, the commonality threshold may require that at least 5% of the monitored data share a commonality to identify a pattern based on that commonality.

In S440, at least one analytic is generated based on the at least one identified pattern. An analytic is an illustrative set of data utilized to demonstrate meaningful patterns in the monitored data. Each analytic may be related to, but is not limited to, a topic, a client device, and a data source. The analytics may include, but are not limited to, data related to the client nodes that edited content related to the topic, data related to the client nodes that searched for the topic, data related to documents associated with the topic and time pointers related to the addition of such documents, and so on. In an embodiment, the analytics may further be based on comparisons among the portions of data.

In a further embodiment, the analytics may be based on comparisons among similar or related patterns. For example, patterns based on related commonalities (e.g., multiple commonalities relating to times of utilization) may be compared. As a non-limiting example, the data may show 4 commonalities, wherein each commonality is based on the quarter of the financial calendar in which purchases of Coca Cola® stock were made. Patterns identified respective of the commonality for each quarter may be compared such that the analytic demonstrates quarterly trends in purchases of Coca Cola® stock.

As a non-limiting example, incoming data is monitored with respect to the topic “purchase of Coca Cola® stock.” Portions of the monitored data related to the topic are analyzed to identify a commonality among the monitored data with respect to purchases of Coca Cola® stock. The identified commonality is that the data is being utilized by being entered into search engines. The portions of data related to the topic “purchase of Coca Cola® stock” that share the commonality of being entered into search engines are grouped and identified as a pattern. Respective of the identified pattern, the portions of data in the pattern grouping are compared. It is determined that a majority of the data portions were entered into search engines in the past week. An analytic about the past week's upsurge in interest in purchasing Coca Cola® stock may be determined. This analytic demonstrates that stock purchasers have begun increasing investments into Coca Cola®.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating analytics based on contextual data, comprising:
identifying at least one tag for a portion of data;
determining at least one topic based on the identified at least one tag, wherein each topic is a descriptive contextual term;
continuously monitoring data from a plurality of data sources respective of each topic; and
generating, for each topic, an analytic based on the monitored data.

2. The method of claim 1, wherein the data sources are cloud-based data sources residing in a plurality of cloud networks.

3. The method of claim 1, wherein the collected data is at least one of: unstructured data, and structured data.

4. The method of claim 1, further comprising:
determining whether each topic appears in the monitored data above a trend threshold; and
upon determining that a topic appears in the monitored data above the trend threshold, determining a trend, wherein the trend is generated as an analytic.

5. The method of claim 1, wherein identifying at least one tag for a portion of data further comprises:
matching the portion to a plurality of textual terms, wherein each tag is assigned to a textual term, wherein each tag assigned to each matching textual term is identified.

6. The method of claim 1, wherein determining at least one topic based on the identified at least one tag further comprises:
matching the identified at least one tag to each tag associated with each topic, wherein a topic is determined if each tag associated with the topic matches one of the at least one identified tag.

7. The method of claim 1, wherein continuously monitoring data from a plurality of data sources respective of each topic further comprises:
gathering, from the monitored data, data related to the at least one topic.

8. The method of claim 1, wherein continuously monitoring data from a plurality of data sources respective of each topic further comprises:
identifying at least one commonality among portions of the monitored data; and
determining at least one pattern based on the at least one commonality.

9. The method of claim 1, wherein the analytic relates to any of: the at least one topic, a client node, and a data source.

10. A non-transitory computer readable medium having stored thereon instructions for causing one or more processing units to execute the method according to claim 1.

11. A system for generating analytics based on contextual data, comprising:
a processing unit; and
a memory, the memory containing instructions that, when executed by the processing unit, configure the system to:
identify at least one tag for a portion of data;
determine at least one topic based on the identified at least one tag, wherein each topic is a descriptive contextual term;
continuously monitor data from a plurality of data sources respective of each topic; and
generate, for each topic, an analytic based on the monitored data.

12. The system of claim 11, wherein the data sources are cloud-based data sources residing in a plurality of cloud networks.

13. The system of claim 11, wherein the collected data is at least one of: unstructured data, and structured data.

14. The system of claim 11, wherein the system is further configured to:
determine whether each topic appears in the monitored data above a trend threshold; and
upon determining that a topic appears in the monitored data above the trend threshold, determine a trend, wherein the trend is generated as an analytic.

15. The system of claim 11, wherein the system is further configured to:
match the portion to a plurality of textual terms, wherein each tag is assigned to a textual term, wherein each tag assigned to each matching textual term is identified.

16. The system of claim 11, wherein the system is further configured to:
match the identified at least one tag to each tag associated with each topic, wherein a topic is determined if each tag associated with the topic matches one of the at least one identified tag.

17. The system of claim 11, wherein the system is further configured to:
gather, from the monitored data, data related to the at least one topic.

18. The system of claim 11, wherein the system is further configured to:
identify at least one commonality among portions of the monitored data; and
determine at least one pattern based on the at least one commonality.

19. The system of claim 11, wherein the analytic relates to any of: the at least one topic, a client node, and a data source.
